(19) United States
(12) Patent Application Publication
(10) Pub. No.: US 2025/0122100 A1
(43) Pub. Date: Apr. 17, 2025

(54) DESALINATION SYSTEM AND METHOD OF USE

(71) Applicant: US Pyramid Project, Winnemucca, NV (US)

(72) Inventors: Crystal Newton, Winnemucca, NV (US); Iram Ramirez Chavira, Puebla (MX)

(21) Appl. No.: 18/912,310

(22) Filed: Oct. 10, 2024

Related U.S. Application Data
(60) Provisional application No. 63/543,673, filed on Oct. 11, 2023.

(51) Int. Cl. C02F 1/04; B01D 1/00; C02F 1/14; C02F 103/00; C02F 103/08

(52) U.S. Cl. CPC C02F 1/048; B01D 1/0035; C02F 1/14; C02F 2103/007; C02F 2103/08

(57) ABSTRACT

In accordance with one embodiment of the present disclosure, a desalination system is for desalinating a liquid is provided. The desalination system can include a thermal device that has an inlet for receiving the liquid and an outlet for discharging the liquid. The thermal device can be configured to heat the liquid as the liquid flows between the inlet and the outlet. The thermal device can also include a desalinating device which can be fluidly coupled to the thermal device such that the desalination is configured to receive the liquid from the outlet of the thermal device. The desalinating device can be configured to desalinate the liquid to produce freshwater.

### CROSS-REFERENCE TO RELATED APPLICATIONS

The present application claims the benefit of, and priority to, U.S. Provisional Patent Application No. 63/543,673 filed Oct. 11, 2023 entitled “DESALINATION SYSTEM AND METHOD OF USE”, the contents of which are hereby incorporated by reference in their entirety.

### BACKGROUND

Freshwater, which can be defined as water containing low concentrations of dissolved minerals (such as salt), is a vital resource for life on Earth. Despite freshwater being a vital resource for life, the overwhelming majority of water found on Earth cannot be classified as freshwater. Instead, only about 3% of all water found on Earth can be classified as freshwater. Unfortunately, not all of this freshwater is readily available for usage. Rather, about one-third of Earth's freshwater is available for usage.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a desalination system for desalinating a liquid is described. The desalination system can include a thermal device having an inlet for receiving the liquid and an outlet for discharging the liquid. The thermal device can be configured to heat the liquid as the liquid flows between the inlet and the outlet. The desalination system can also include a desalinating device fluidly coupled to the thermal device such that the desalinating device is configured to receive the liquid from the outlet of the thermal device. The desalinating device can be configured to desalinate the liquid to produce freshwater.

In accordance with another embodiment of the present disclosure, a desalinating device for desalinating a liquid is described. The desalinating device can include a wall member having a first end and a second end and defining an inner volume extending between. The desalinating device can also include a roof member coupled to the first end of the wall member and a plurality of tray members coupled to the roof member. Each tray member can be configured to hold the liquid.

In accordance with another embodiment of the present disclosure, a method of desalinating a liquid is described. The method can include pumping the liquid to a thermal device; heating the liquid with the thermal device to a temperature; pumping the liquid to a desalinating device; and desalinating the liquid with the desalinating device to produce freshwater.

In any of the embodiments described herein, the desalinating device can include a wall member that extends between a first end and a second end and defines an inner volume for receiving the liquid.

In any of the embodiments described herein, the wall member can include a channel at or near the second end of the wall member for collecting the freshwater.

In any of the embodiments described herein, the desalinating device can include a plurality of tray members disposed within the inner volume defined by the wall member, and the plurality of tray members can be configured to hold at least a portion of the liquid.

In any of the embodiments described herein, the wall member can define an inner face, and each tray member of the plurality of tray members can be spaced apart from the inner face.

In any of the embodiments described herein, the plurality of tray members can be positioned in a staggered arrangement.

In any of the embodiments described herein, each tray member of the plurality of tray members can define a first end for discharging the held liquid and a second end for receiving liquid.

In any of the embodiments described herein, the first end can include a wall having a lowered portion.

In any of the embodiments described herein, the second end can include a wall having a raised portion.

In any of the embodiments described herein, the first and second ends of the plurality of tray members can be positioned in an alternating arrangement within the inner volume.

In any of the embodiments described herein, the desalinating device can include a roof member coupled to the first end of the wall member, and the plurality of tray members can be coupled to the roof member.

In any of the embodiments described herein, the plurality of tray members can be free hanging from the roof member.

In any of the embodiments described herein, the plurality of tray members can be coupled to a rod extending between the roof member and a base member.

In any of the embodiments described herein, the thermal device can include an inlet pipe having an inner bore that defines the inlet and an outlet pipe having an inner bore that defines the outlet.

In any of the embodiments described herein, the longitudinal axis of the inlet pipe can be substantially parallel to the longitudinal axis of the outlet pipe.

In any of the embodiments described herein, the thermal device can include a pipe member having a first end coupled to the inlet pipe and a second end coupled to the outlet pipe, and the pipe member can fluidly couple the inlet pipe to the outlet pipe.

In any of the embodiments described herein, the longitudinal axis of the pipe member can be substantially perpendicular to the longitudinal axis of the inlet pipe.

In any of the embodiments described herein, the desalination system can further include a support member coupled to the thermal device, wherein the support member is configured to support the thermal device at a non-zero angle with respect to a horizontal plane.

In any of the embodiments described herein, the non-zero angle can be at least about 15 degrees.

In any of the embodiments described herein, the desalination system can further include a pump fluidly coupled to the thermal device and the desalination device, and the pump can be configured to pump the liquid through the thermal device and the desalination device at a flow rate between about 1 gallon per minute to about 3 gallons per minute.

In any of the embodiments described herein, each tray member of the plurality of tray members can be spaced apart from the wall member.

In any of the embodiments described herein, the roof member can define a channel for receiving the liquid.

In any of the embodiments described herein, the desalinating device can further include a base member coupled to the second end of the wall member.

In any of the embodiments described herein, the base member can define a first outlet for discharging wastewater and a second outlet for discharging freshwater.

In any of the embodiments described herein, the desalinating device can include a wall member that extends between a first end and a second end and defines an inner volume for receiving the liquid.

In any of the embodiments described herein, desalinating the liquid can include evaporating the liquid to produce water evaporation.

In any of the embodiments described herein, the method can further include capturing the water evaporation.

In any of the embodiments described herein, the method can further include directing the water evaporation to an inner face of the wall member.

In any of the embodiments described herein, the desalinating device can include a plurality of tray members disposed within the inner volume defined by the wall member, and the plurality of tray members can be configured to hold at least a portion of the liquid.

In any of the embodiments described herein, each tray member of the plurality of tray members can be spaced apart from the wall member.

In any of the embodiments described herein, the thermal device can include an inlet pipe having an inner bore that defines an inlet for receiving the liquid, an outlet pipe having an inner bore that defines an outlet for discharging the liquid, and a pipe member coupled to and extending between the inlet pipe and outlet pipe.

In any of the embodiments described herein, heating the liquid can include pumping the liquid from the inlet pipe, through the pipe member, and to the outlet pipe.

In any of the embodiments described herein, the liquid can be pumped at a flow rate of at least about 2 gallons per minute.

In any of the embodiments described herein, the outlet pipe can be positioned above the inlet pipe relative to a ground surface.

In any of the embodiments described herein, the temperature is between about 140 degrees Fahrenheit to about 150 degrees Fahrenheit.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 illustrates a schematic diagram of an exemplary desalination system in accordance with one or more embodiments of the present disclosure.

FIG. 2 illustrates a schematic diagram of a thermal system in accordance with one or more embodiments of the present disclosure.

FIG. 3 illustrates a perspective view of an exemplary thermal device in accordance with one or more embodiments of the present disclosure.

FIG. 4 illustrates a schematic diagram of a desalinating system in accordance with one or more embodiments of the present disclosure.

FIG. 5 illustrates a perspective view of an exemplary desalinating device in accordance with one or more embodiments of the present disclosure.

FIG. 6 illustrates a perspective view of the desalinating device of FIG. 5 with a wall member hidden for clarity.

FIG. 7 illustrates a side view of the desalinating device of FIG. 6.

FIG. 8 a perspective view of the desalinating device of FIG. 5 with several components hidden for clarity.

FIG. 9 illustrates a perspective view of a roof member of the desalinating device of FIG. 5

FIG. 10 illustrates a perspective view of a base member of the desalinating device of FIG. 5.

FIG. 11 illustrates a perspective view of tray member in accordance with one or more embodiments of the present disclosure.

FIG. 12 illustrates a perspective view of a portion of the wall member of the desalinating device of FIG. 5.

FIG. 13 is a flow diagram illustrating an example method for desalinating water in accordance with one or more embodiments of the present disclosure.

### DETAILED DESCRIPTION

Most communities around the world rely on natural occurring freshwater sources to meet their water needs. With freshwater accounting for such a limited amount of the total water found on Earth, freshwater scarcity has become an issue. This issue is becoming more prevalent across the world with changes to the climate and increases in the overall global population. Accordingly, there exists a need for providing freshwater from sources other than naturally occurring freshwater sources.

One process for providing freshwater can involve desalination, which is a process that can remove salt and other minerals from seawater (e.g., saltwater) to produce freshwater. Conventional desalination processes can be used to turn readily available (but otherwise unusable) seawater into freshwater. However, in many instances, these conventional processes can be very energy intensive and can produce harmful waste products (e.g., brine waste), which can render these conventional desalination process unattractive. Accordingly, there exists a need for an improved desalination process.

Embodiments of the present disclosure can address these and other issues of desalination. In some examples, embodiments of the present disclosure relate to a desalination system. The desalination system can include several subsystems and components which allow for the desalination to produce freshwater from a suitable liquid. In some examples, the desalination system can utilize a desalinating device to produce freshwater. The desalinating device can intake water, evaporate this water, and capture the evaporated water as freshwater. The desalinating system can also include a thermal system that can be coupled to the desalinating device. The thermal system can heat up water by routing water through pipes exposed to sunlight. This heated water can be delivered to the desalinating device, which can allow for evaporation to occur more readily within the desalinating device. These and other aspects of the present disclosure will be more fully described below.

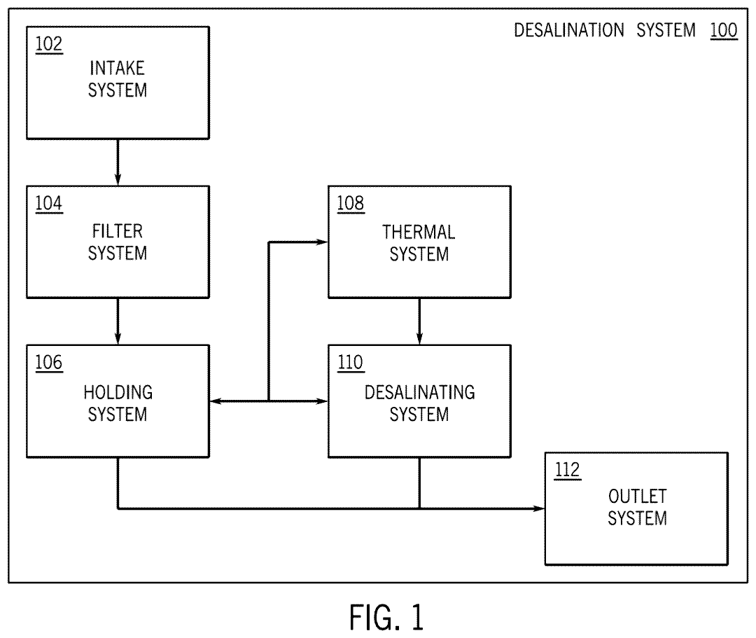

FIG. 1 illustrates a schematic diagram of a desalination system 100 in accordance with exemplary embodiments of the present disclosure. In general, the desalination system 100 can include an intake system 102 for intaking water into the desalination system 100, a filter system 104 for filtering the water, a holding system 106 for holding (or storing) water, a thermal system 108 for heating water, a desalinating system 110 for desalinating water, and an outlet system 112 for outputting water. As will be described in more detail herein, these (and other) components of the desalination system 100 can be configured so that the desalination system 100 can produce freshwater from a saltwater (or other liquid) source.

The intake system 102 can be any suitable system for intaking or delivering water into the desalination system 100. For instance, in some examples, the intake system 102 can include a canal, piping, a pump, and/or other components that can be used to direct water from a water source into the desalination system 100. In some examples, the intake system 102 can be configured to deliver water from a body of water (e.g., such as an ocean, lake, river, etc.), into the desalination system 100. In some of these examples, or otherwise, the intake system 102 can rely on currents, tides, gravity, and other naturally occurring phenomena to help direct water into the desalination system 100 without needing to rely significantly on external sources of power (e.g., a pump).

The filter system 104 can be any suitable system for filtering water so that the filtered water is safe for processing by the desalination system 100. In some examples, the filter system 104 can include any suitable components for filtering out debris, such as sand, rocks, plants, animals, and other material from the water. In some embodiments, the filter system 104 is coupled to the intake system 102 so that the filter system 104 can filter water directly from the intake system 102. Additionally, or alternatively, the filter system 104 can couple to other systems (e.g., the holding system 106, thermal system 108, etc.) to filter water inputted into or discharged from those systems.

The holding system 106 can be any suitable storage system within the desalination system 100 that is configured to hold and/or store water or other material. In some examples, the holding system 106 can be configured to hold saltwater (e.g., seawater, saline water, hypersaline water, etc.). For instance, the holding system 106 can be a reservoir (e.g., a pond), a container suitable for holding saltwater, or a combination of reservoirs and containers. In some examples, the holding system 106 can be configured to hold other liquids or materials, such as (but not limited to) freshwater and waste. Additionally, the holding system 106 can include any suitable components from pumping water (or other materials, liquids, etc.) to and from the holding system 106 as desired. In various embodiments, the holding system 106 can include several reservoirs and/or containers that are coupled to several systems within the desalination system 100 for storage and which can be configured to store a combination of saltwater, freshwater, waste, or other material.

In some examples, the holding system 106 can include one or more evaporation ponds that are configured to hold waste from the desalination process. In some of these examples, or otherwise, the waste can include any water (or other liquid) that is a byproduct from the desalination process (e.g., the non-freshwater), including hypersaline water (e.g., seawater with a higher-than-normal concentration of salt and/or minerals) or unused water. By storing waste in an evaporation pond, some of the water within the waste can further evaporate, which can leave behind a higher concentrated saline solution (e.g., a brine slurry) that is easier to dispose of.

The thermal system 108 can be any suitable system that is configured to heat water. For example, as will be described in more detail herein, the thermal system 108 can include one or more thermal devices 118, which can be configured to generate (or collect) heat and transfer that heat to the water running through the thermal devices 118. In some embodiments, the thermal system 108 can rely on (in part or entirely) solar energy as a heat source. For example, the thermal devices 118 can be configured to capture solar energy as heat and apply that captured heat to the water running through the thermal devices 118. The thermal system 108 can be coupled to one or more systems within the desalination system 100 so that water can be delivered to and from the thermal system 108 as desired.

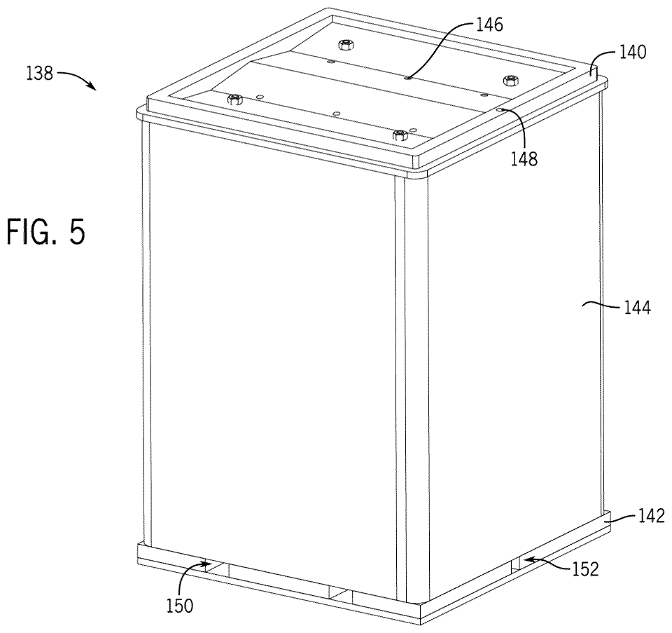

The desalinating system 110 can be any suitable system that is configured to desalinate water (or other liquid). In some examples, the desalinating system 110 can be configured to desalinate water through evaporation. For instance, the desalination system 110 can include one or more desalinating devices 138 (as shown in FIG. 5), which can intake and route water through the desalinating device 138 so that the water within evaporates to remove (or separate) salt and other minerals from the evaporated water. This evaporated water can then be collected as freshwater to complete the desalinating process. In some embodiments, the desalinating system 110 can be coupled to the thermal system 108 so that the desalinating system 110 can received heated water from the thermal system 108, which can improve the efficiency of the desalination process. The desalinating system 110 can be coupled to other systems in addition to (or in lieu of) the thermal system 108, including, for instance, the holding system 106.

The outlet system 112 can be any suitable system that is configured to direct water (or waste) out of the desalination system 100. For instance, in some examples, the outlet system 112 can include a canal, piping, a pump, and/or other components that can be used to direct water or waste out of the desalination system 100.

While the illustrated embodiment shows the desalination system 100 as including an intake system 102, a filter system 104, a holding system 106, a thermal system 108, a desalinating system 110, and an outlet system 112, it should be appreciated that the desalination system 100 may include additional systems or may include fewer systems than those already described. As one non-limiting example, in some embodiments, the desalination system 100 can include one or more pumping systems, which can be used to pump water to and from the systems within the desalination system 100. As another non-limiting example, the desalination system 100 can include a treatment system, which can treat water from the water intake so that the water is safe to desalinate. These and other arrangements of the desalination system 100 are within the scope of the present disclosure.

With the schematic of FIG. 1 in mind, an example operation of the desalination system 100 will now be described. First, the intake system 102 can direct water from a water source into the desalination system 100. In some instances, this water can be directed into a reservoir or other storage system within the holding system 106, where the water can be held until it is ready for use. In other examples, the water from the intake system 102 can be directed to the filter system 104, where the water can be filtered to remove debris from the water so that the water is suitable to run through other systems within the desalination system 100 (e.g., the thermal system 108, desalinating system 110, etc.). Once filtered, the filtered water can be held in storage within the holding system 106 until the filtered water is ready for use, or the water can be directed to the thermal system 108, where the water can be heated. Once heated, the heated water can then be directed to the desalinating system 110, where the water can be desalinated to produce freshwater. The freshwater produced by the desalinating system 110 can be captured by the desalinating system 110 and held in storage within the holding system 106. Any waste (e.g., wastewater, hypersaline water, saltwater, etc.) can be directed to a storage system within the holding system 106 where the waste can be held until it is ready for disposal. In some examples, however, the waste may be recycled through both the thermal system 108 and the desalinating system 110 in order to capture additional freshwater from the waste. The captured freshwater can eventually (or directly) be delivered to the outlet system 112, where the freshwater can be directed to its desired location. Similarly, the remaining waste can be directed to the outlet system 112 for disposal or safely stored within the holding system 106.

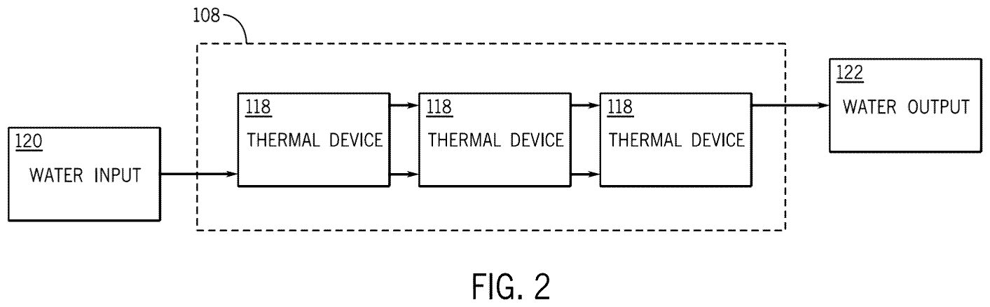

Additional details of the desalination system 100 will now be described. FIG. 2 illustrates a schematic diagram of a thermal system 108. As shown in FIG. 2, the thermal system 108 can include the thermal devices 118 for heating water and can include a water input 120 and water output 122 for directing water into and out of the thermal system 108.

The water input 120 and water output 122 can include any suitable components for directing water into and out of the thermal system 108. For example, both the water input 120 and water output 122 can include one or more pipes, pumps, valves, and/or other components which can help pump water to and through the thermal system 108 at a desired flow rate. In some instances, the water input 120 can be a suitable waterline that can deliver water to each of thermal devices 118 within the thermal system 108 and the water output 122 can be a suitable waterline for removing heated water from the thermal system 108.

While the illustrated embodiment shows the thermal system 108 as including (or coupling to) a water input 120 and a water output 122, it should be appreciated that the thermal system 108 may receiving and discharge water in other suitable manners. For example, in some embodiments, the thermal system 108 may couple directly to a separate system within the desalination system 100 to receive and discharge water and can thus exclude the water input 120 and/or water output 122. These and other arrangements of the thermal system 108 are within the scope of the present disclosure.

As previously described, the thermal system 108 can include one or more thermal devices 118 that can each generate or capture heat and transfer that generated or captured heat to water running through each thermal device 118. In the illustrated embodiment, the thermal system 108 can include three separate thermal devices 118 that are coupled together and coupled to the water input 120 and water output 122. However, in other embodiments, the thermal system 108 can include fewer or more thermal devices 118. In some of these embodiments, or otherwise, the thermal devices 118 can be arranged in parallel or coupled to one another. In some instances, the thermal devices 118 can define a fluid path for the water to flow through each of the thermal devices 118. For examples, the thermal devices 118 can include a series of interconnected pipes that can define a fluid path for water to flow through. In some of these examples, or otherwise, the pipes can be exposed to sunlight and thus become heated under the sunlight. Accordingly, as the water flows through the thermal devices 118, the water can be heated to the desired temperature by being exposed to the heated pipes.

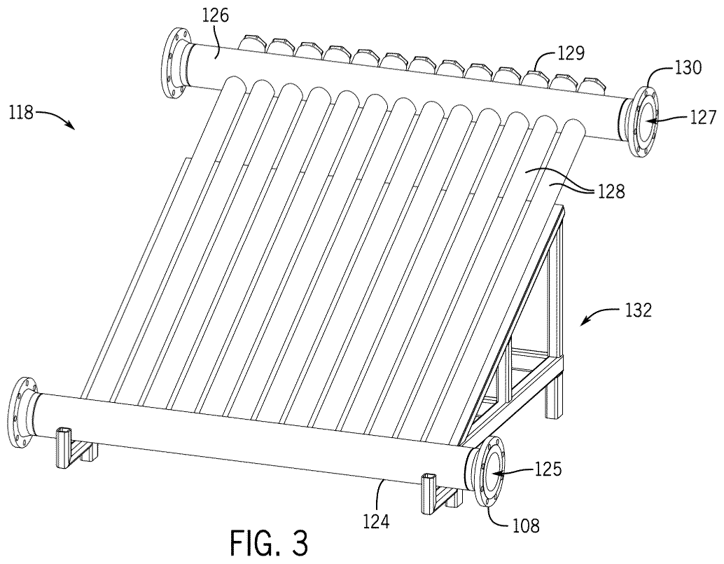

FIG. 3 illustrates a perspective view of an example thermal device 118. As shown in FIG. 3, the thermal device 118 can include an inlet pipe 124, an outlet pipe 126, and one or more pipe members 128. The inlet pipe 124 and the outlet pipe 126 can each be an elongated pipe (or other tubular member) that extends across the width of the thermal device 118. The inlet pipe 124 and outlet pipe 126 can also each define a fluid path for water to flow within, with the inlet pipe 124 being configured to intake water into the thermal device 118 and the outlet pipe 126 being configured to discharge water from the thermal device 118. Accordingly, in some examples, the inlet pipe 124 can include an inner bore that extends the length of the inlet pipe 124 and can define an inlet 125 at either (or both) ends of the inlet pipe 124 for receiving water. Similarly, the outlet pipe 126 can include an inner bore that extends the length of the outlet pipe 126 and can define an outlet 127 at either (or both) ends of the outlet pipe 126 for discharging water. In some embodiments, the inlet and outlet pipes 124, 126 can include one or more features for coupling the thermal devices 118 to other systems or components. For example, as shown in FIG. 3, the inlet and outlet pipes 124, 126 can include flanges 130 at the ends of the respective inlet and outlet pipes 124, 126. In some examples, the longitudinal axes of the inlet pipe 124 and the outlet pipe 126 can be substantially parallel to one another. Additionally, or alternatively, the inlet and outlet pipes 124, 126 can form at least a portion of the water input 120 and water output 122 of the thermal system 108.

The pipe members 128 can be configured for fluidly coupling the inlet pipe 124 and the outlet pipe 126 together. The pipe members 128 can each be an elongated member that couples to, and extends between, the inlet pipe 124 and the outlet pipe 126. The pipe members 128 can also define an inner bore that extends along the length of the pipe member 128 and can include an aperture at (or near) each end of the pipe members 128. In some examples, the inner bore and the apertures can define a path for water to flow between the pipe members 128 and the inlet and outlet pipes 124, 126. Accordingly, in some examples, the inlet pipe 124, the outlet pipe 126, and the pipe members 128 can define the fluid path for water to flow within the thermal devices 118. As shown in FIG. 3, in some examples, an end of the pipe member 128 can extend through the outlet pipe 126 (or inlet pipe 124). This end can define a port 129 which can allow access to the inner bore of the pipe member 128 for cleaning, maintenance, or other purpose. In some examples, the longitudinal axis of the pipe member 128 can be substantially perpendicular to the inlet pipe 124 and outlet pipe 126 when coupled to the inlet and outlet pipes 124, 126.

In the illustrated embodiment, the thermal device 118 includes thirteen (13) pipe members 128 positioned in a side-by-side manner across the width of the thermal device 118. However, it should be appreciated that the pipe members 128 can be arranged in other manners within the thermal device 118. As one non-limiting example, the thermal device 118 can include additional or fewer pipe members 128 coupled to the inlet and outlet pipes 124, 126. As another non-limiting example, the pipe members 128 can be coupled together to form a lengthened fluid path between the inlet and outlet pipes 124, 126. In some of these examples, or otherwise, the fluid path can zigzag between the inlet and outlet pipes (e.g., the fluid path extends from the inlet pipe 124, to the outlet pipe 126, and back to the inlet pipe 124). These and other arrangements of the pipe members 128 are within the scope of the present disclosure.

In operation, water from the water input 120 (or other source) can be delivered into the thermal device 118 via the inlet 125 formed in the inlet pipe 124. As water fills the inlet pipe 124, the water can begin to flow to the outlet pipe 126 by flowing through the fluid pathway formed within the pipe members 128. The water that reaches the outlet pipe 126 can continue flowing through the outlet pipe until the water is discharged out of the outlet 127 of the outlet pipe 126 and to the water output 122 (or other source).

In some examples, the inlet and outlet pipes 124, 126 of one thermal device 118 can be coupled to the inlet and outlet pipes 124, 126 of a separate thermal device 118. This arrangement can fluidly couple the respective inlet pipes 124 and outlets pipes 126 of two or more thermal devices 118, which, in some examples, can thereby create a single inlet 125 and a single outlet 127 for the thermal system 108. Accordingly, in some arrangements, water can be delivered to several thermal devices 118 by first flowing through a single inlet pipe 124 of a thermal device 118 within the thermal system 108. Similarly, water can flow through one or more outlet pipes 126 before finally being discharged out a single outlet pipe 126 of a thermal device 118 within the thermal system 108. Thus, in some examples, the thermal system 108 can have a single waterline in and a single waterline out of the thermal system 108 (e.g., a single water input 120 and a single water output 122). In various embodiments, the inlet pipes 124 can form at least a portion of the water input 120 and the outlet pipes 126 can form at least a portion of the water output 122.

As previously described, the water flowing within the thermal device 118 can be heated, including with sunlight. For example, the inlet pipe 124, outlet pipe 126, and/or pipe members 128 can be formed from a material (e.g., steel, copper, etc.) that can heat up when exposed to sunlight. Thus, as the inlet pipe 124, outlet pipe 126, and/or pipe members 128 heat up from being exposed to the sunlight, these components can transfer at least some of this heat gained to the water flowing through the respective components of the thermal device 118. In various embodiments, the thermal devices 118 can be configured to be more conducive to capturing heat from sunlight. As one non-limiting example, a dark colored paint (or other thermal paint/substance) can be applied to any of the inlet pipe 124, outlet pipe 126, and pipe members 128 for improving the thermal conductivity of the thermal devices 118.

While the inlet pipe 124, outlet pipe 126, and pipe members 128 are described as being formed from a metallic material, such as steel, it should be appreciated that these components may be formed from other materials. As one example, in some embodiments, the inlet pipe 124, outlet pipe 126, and/or pipe members 128 can be formed from a transparent material, such as glass. As another example, the inlet pipe 124, outlet pipe 126, and/or pipe members 128 can be formed from a plastic material, such as PVC. In some embodiments, the inlet pipe 124, outlet pipe 126, and/or pipe members 128 can be formed from a combination of these materials. These and other arrangements of the thermal devices 118 are within the scope of the present disclosure.

In some instances, the thermal system 108 can include a separate heat source that can be used in addition to (or in lieu of) sunlight. For example, a heated jacket can be positioned around portions of the thermal device 118 so that heat generated by the jacket can be transferred to the water flowing through the thermal device 118. As another example, an external boiler can be coupled to the thermal devices 118 so that heat generated by the boiler can be transferred to the water flowing through the thermal device 118.

Still referring to FIG. 3, in some examples, the thermal device 118 can include a support member 132. The support member 132 can be coupled to the inlet pipe 124, outlet pipe 126, and/or pipe members 128 and can be configured for supporting these components of the thermal device 118. For example, in the illustrated embodiment, the support member 132 is a stand that is coupled to the inlet pipe 124 and pipe members 128 for supporting the thermal device 118. In some instances, the support member 132 can be configured to position the inlet pipe 124, outlet pipe 126, and pipe members 128 at an angled position (e.g., non-zero angle) relative to a horizontal plane. For examples, as shown in FIG. 3, the support member 132 is supporting the inlet pipe 124, outlet pipe 126, and pipe members 128 at a 30-degree angled position relative to a horizontal plane. By positioning the inlet pipe 124, outlet pipe 126, and pipe members 128 at an angled position, the inlet pipe 124, outlet pipe 126, and pipe members 128 can be better suited for absorbing sunlight for heating water flowing within thermal device 118. In some examples, the support member 132 can angle the inlet pipe 124, outlet pipe 126, and pipe members 128 between about 5 and 75 degrees relative to a horizontal plane. As shown in FIG. 3, in some embodiments, the support member 132 can position the outlet pipe 126 above the inlet pipe 124 relative to a ground surface.

In some examples, it may be desirable to control the flow rate of water within the thermal system 108. For instance, if water flows throughout each of the thermal devices 118 at too high of a flow rate, the water within the thermal devices 118 may not be exposed to the heated pipes for a long enough duration to reach the desired temperature. To control the flow rate of water within the thermal system 108, the pumps pumping water into and out of the thermal system 108 (e.g., the pumps within the water inlet 120 and/or water outlet 122) can be configured so that water flows through the thermal system 108 at the desired flow rate. In some examples, the optimal flow rate of water flowing through the thermal system 108 can be at least about 0.5 gallons per minute, at least about 1 gallons per minute, at least about 1.5 gallons per minute, at least about 2 gallons per minute, at least about 2.5 gallons per minute, at least about 3 gallons per minute, at least about 3.5 gallons per minute, at least about 5 gallons per minute, at least about 10 gallons per minute, at least about 25 gallons per minute, or more.

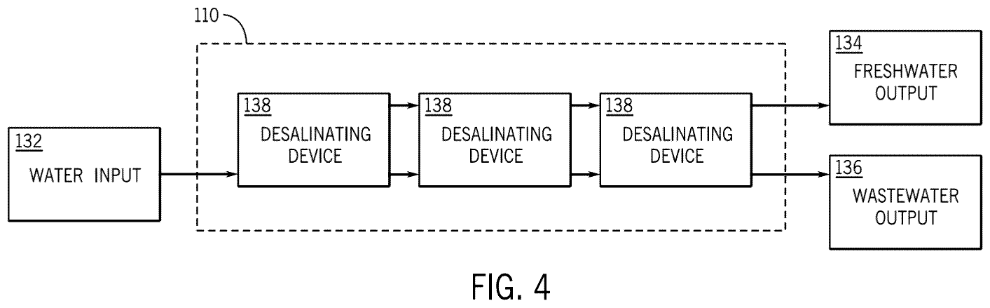

Additional details of the desalinating system 110 will now be described. FIG. 4 illustrates a schematic diagram of a desalinating system 110. As shown in FIG. 4, the desalinating system 110 can include the desalinating devices 138 for desalinating water. The desalinating system can also include a water input 132 for receiving water, a freshwater output 132 for discharging freshwater, and a wastewater output 134 for discharging wastewater (or waste). The water input 132, freshwater output 134, and the wastewater output 136 can be coupled to each of the desalinating devices 138 and can include any suitable components for directing water into and out of the desalinating system 110. For instance, the water input 132, freshwater output 134, and the wastewater output 136 can include one or more pipes, pumps, valves, and/or other components which can help pump water to and through the desalinating system 110 at the desired flow rate. In some embodiments, the water input 132, freshwater output 134, and the wastewater output 136 can be any suitable waterline (as indicated by the arrows) for carrying water into and out of the desalinating system 110. In some examples, the water input 132 can be coupled to (or replaced by) the water output 122 of the thermal system 108.

In some examples, the desalinating devices 138 can be coupled to one another so that the desalinating system 138 has a single waterline into the desalinating system 110 (e.g., the water input 132), a single freshwater line out of the desalinating system 110 (e.g., the freshwater output 134), and a single wastewater line out of the desalinating system 110 (e.g., the wastewater output 136). In some of these examples, or otherwise, the desalinating devices 138 can be arranged in a stack with one desalinating device 138 placed on top of a second desalinating device 138.

While the illustrated embodiment shows the desalinating system 110 as including (or coupling to) a water input 132, a freshwater output 134, and a wastewater output 136, it should be appreciated that the desalinating system 110 may instead exclude the water input 132, the freshwater output 134, and/or the wastewater output 136. For example, in some embodiments, the desalinating system 110 may couple directly to a separate system within the desalination system 100 to receive and discharge water. These and other arrangements of the desalinating system 110 are within the scope of the present disclosure.

As previously described, water (or other liquid) delivered to the desalinating system 110 can be desalinated by the desalinating devices 138 to produce freshwater and wastewater (e.g., unused water, saltwater, hypersaline water, waste, etc.). In some instances, the desalinating devices 138 can desalinate water through evaporation. For example, water delivered to the desalinating devices 138 can be routed through the desalinating devices 138, which can include one or more components for holding some volume of water within the desalination device 138. This held water can evaporate within the desalinating devices 138 to produce water evaporation. The water evaporation can be directed to the walls of the desalinating device 138, where the evaporation can condense as freshwater and be collected. The remaining water (e.g., the non-evaporated water) can be collected as wastewater, which can be recycled through the desalination device 138 to produce more freshwater or can be disposed as waste.

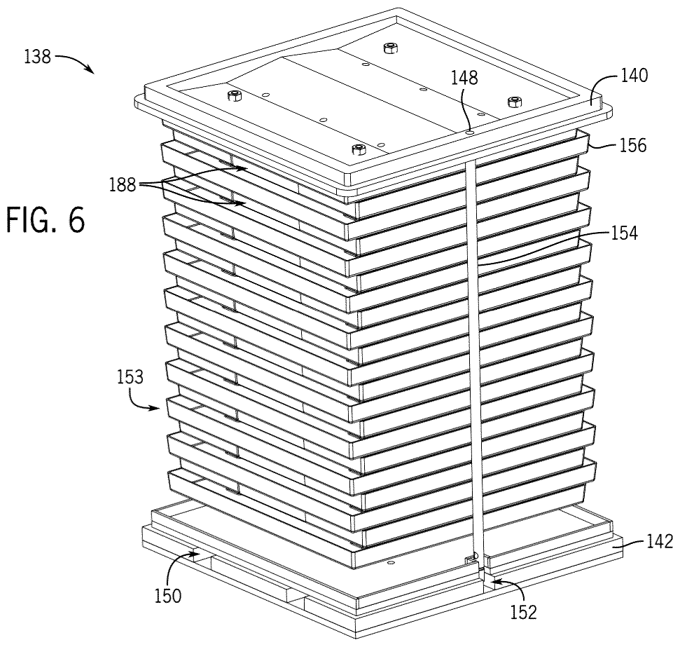

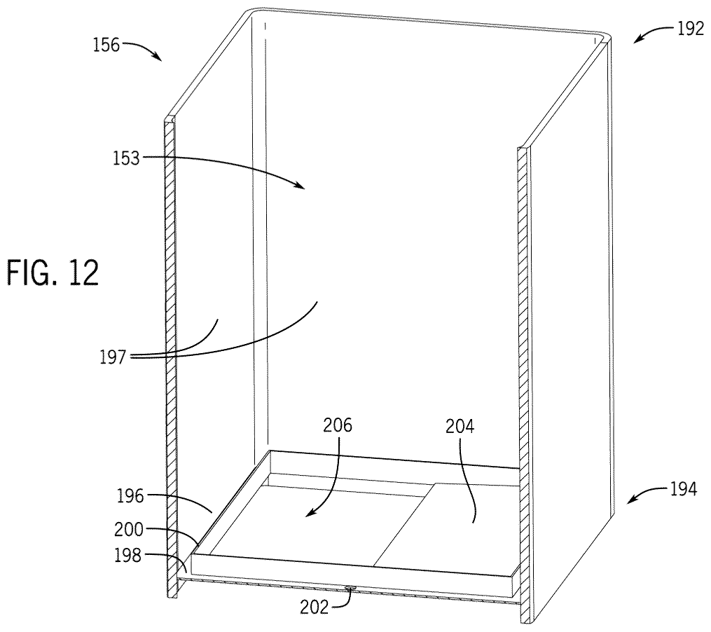

FIG. 5 illustrates a perspective view of a desalinating device 138. As shown in FIG. 5, the desalinating device 138 can include a roof member 140, a base member 142, and a wall member 144 extending between the roof and base members 140, 142. The roof member 140 can define the upper end of the desalinating device 138 and, as will be described in more detail herein, can include one or more first inlets 146 and second inlets 148 for intaking water into the desalinating device 138. The base member 142 can define the lower end of the desalinating device 138 and can provide support to the desalinating device 138. As shown in FIG. 5, the base member 142 can include one or more first outlets 150 and second outlets 152 for discharging water and/or waste. The wall member 144 can enclose and define an inner volume (e.g., the inner volume 153 as shown in FIGS. 6, 12) between the roof member 140 and the base member 142. As will be described in more detail herein, in some examples, the wall member 144 can be configured to collect freshwater produced from the desalination process.

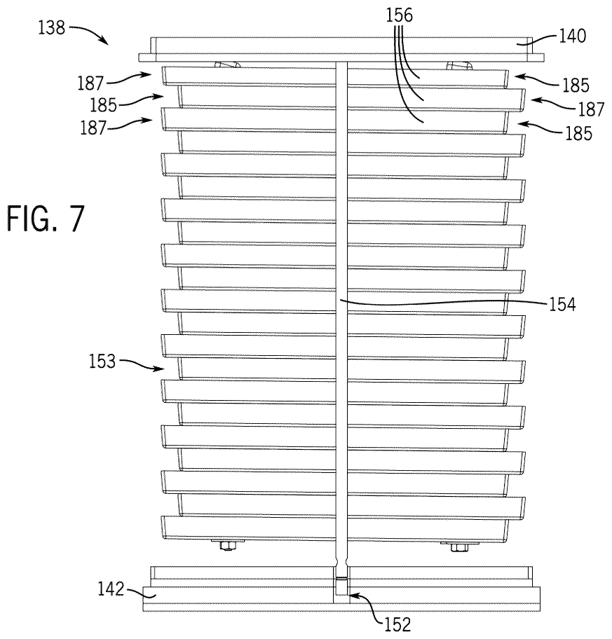

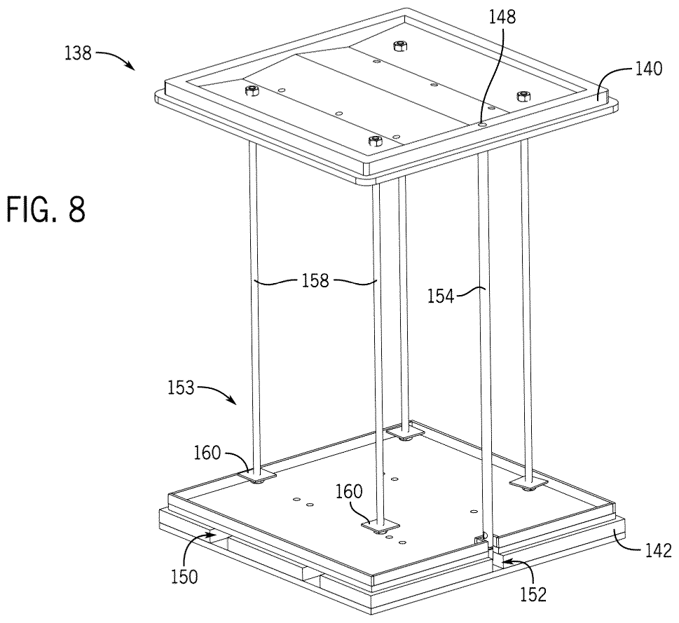

FIGS. 6-8 illustrate various views of the desalinating device 138 with the wall member 144 removed for clarity. As shown in FIGS. 6-8, the desalinating device 138 can define an inner volume 153 that extends between the roof member 140 and the base member 142. In some examples, the desalinating device 138 can include a waterline 154 that extends between the roof member 140 and the base member 142. The waterline 154 can be configured to provide a fluid path between the second inlet 148 and the second outlet 152 for water to flow through at least a portion of the inner volume 153 of the desalinating device 138. Referring now to FIGS. 6 and 7, the desalinating device 138 can include several tray members 156 that are disposed between the roof member 140 and base member 142. The tray members 156 can be configured to receive and hold water which can assist with the desalination process by, for instance, providing an area for the held water to evaporate. Referring again to FIGS. 6-8, the tray members 156 can be supported by one or more supporting members 158. The supporting members 158 can be any suitable elongated member (e.g., a rod) for supporting the tray members 156. As shown in FIG. 8, the supporting members 158 can be coupled to the roof member 140 and can extend towards and couple to the base member 142. In the illustrated embodiment, the supporting members 158 are spaced apart from the base member 142, which results in the supporting members 158 being free hanging from the roof member 140. In some of these embodiments, or otherwise, a plate 160 can be attached to the end of each supporting member 158 to provide additional support to the tray members 156.

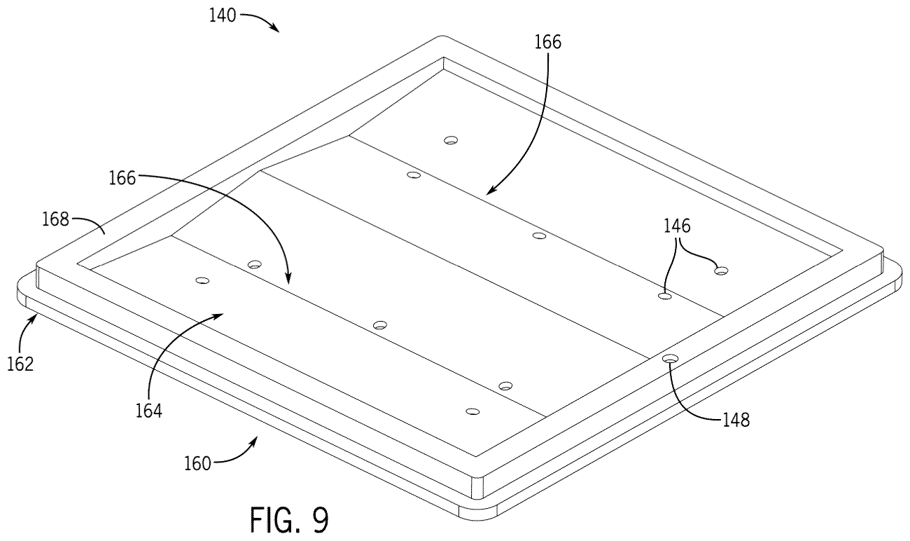

FIG. 9 illustrates a perspective view of the roof member 140. As previously described, the roof member 140 can define the upper end of the desalinating device 138 and, in some instances, can provide an intake for allowing water to flow into the desalinating device 138. As shown in FIG. 9, the roof member 140 can include a body 160 having an outer portion 162 and an inner portion 164. The outer portion 162 can define the outer perimeter of the roof member 140 and can be sized and shaped such that a base member 142 or a wall member 144 can be disposed on top of the roof member 140 (e.g., when a first desalinating device 138 is stacked on top of a second desalinating device 138). Accordingly, in some examples, the roof member 140 can be configured as the interface between two desalinating devices 138. The inner portion 164 can define one or more channels 166 for receiving water. As shown in FIG. 9, the channels 166 can be angled so that water placed in the channels 166 can flow in the desired direction, including towards the one or more first inlets 146 which can be disposed within the channels 166. The first inlets 146 can provide access for water to flow into the inner volume 153 of the desalinating device 138. Accordingly, in some examples, water pumped into the channels 166 can flow into the desalinating device 138 via the first inlets 146. In some embodiments, the channels 166 can be defined, in part, by a wall 168 which can surround the channels 166. As illustrated in FIG. 9, in some examples, the wall 168 can be spaced apart from the outer edge of the body 160, which can assist with coupling a wall member 144 or base member 142 to the roof member 140. In some embodiments, the second inlet 148 can be disposed on the wall 168, as shown in FIG. 9.

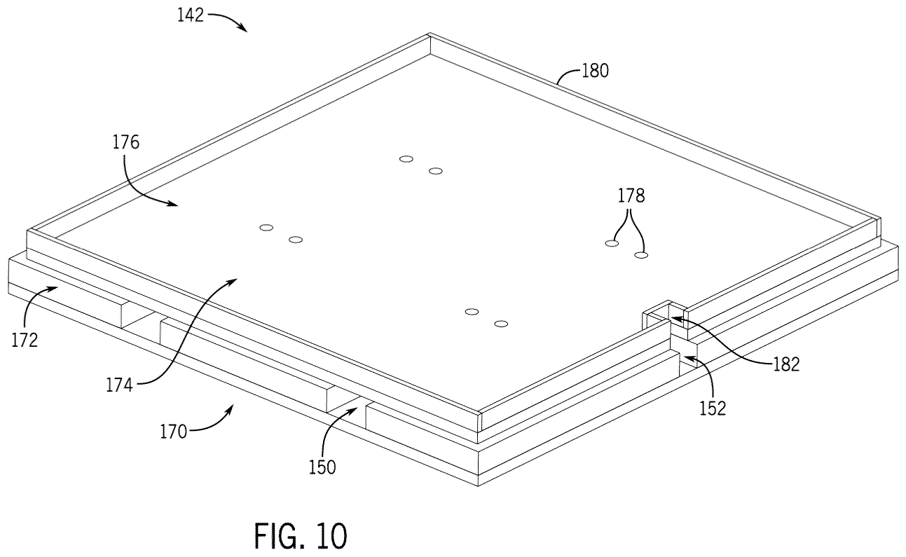

FIG. 10 illustrates a perspective view of the base member 142. As previously described, the base member 142 can define the lower end of the desalinating device 138 and can provide support to the desalinating device 138. As shown in FIG. 10, the base member 140 can include a body 170 having an outer portion 172 and an inner portion 174. The outer portion 172 can define the outer perimeter of the base member 142 and can be sized and shaped such that the wall member 144 can be coupled to base member 142 and be substantially flush with the outer edge of the base member 142. In some embodiments, the first outlets 150 and second outlets 152 can be positioned along the outer portion 172. The inner portion 174 can define a channel 176 for receiving water. In some examples, the channel 176 can be angled so that water within the channel 176 can flow (or drain) to the desired location within the channel 176. As shown in FIG. 10, one or more apertures 178 can be formed within the channel 176. The apertures 178 can provide access for water within the channel 176 to flow into the first outlets 150. Thus, in some embodiments, the apertures 178 can be fluidly coupled to the first outlets 150. In some examples, the channel 176 can be defined, in part, by a wall 180 that extends around the perimeter of the channel 176. In some of these examples, or otherwise, the wall 180 can define an aperture 182 for receiving water, including, in some instances, freshwater produced from the desalination process. The aperture 182 can be disposed on the outer side of the wall 180 and opposite of the channel 176 so that the aperture 182 is not fluidly coupled with the channel 176 or aperture 178. In some examples, the aperture 182 can be fluidly coupled with the second outlet 152 so that water flowing through the aperture 182 can flow into the second outlet 152.

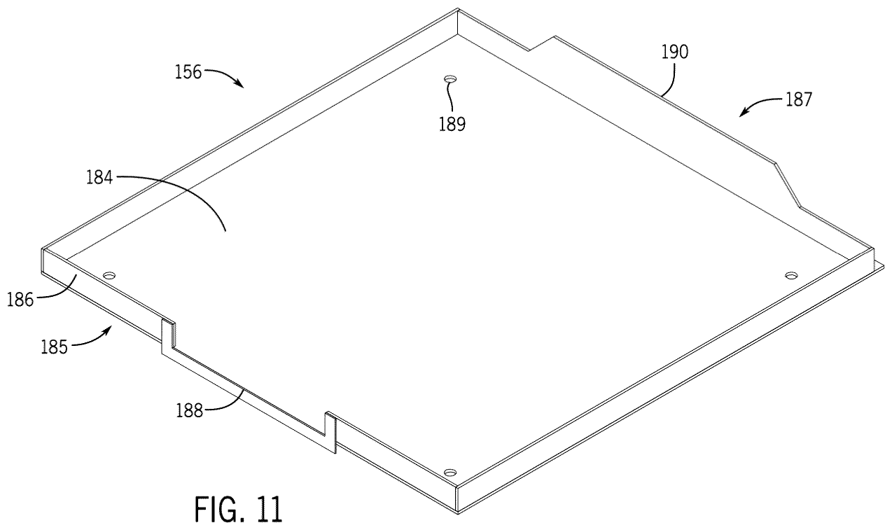

FIG. 11 illustrates a perspective view of the tray member 156. As previously described, the tray members 156 can be configured to receive and hold water to assist with the desalination process. As shown in FIG. 11, the tray member 156 can include a base 184 that extends between a first end 185 and a second end 187. The base 184 can include a wall member 186 extending around the perimeter of the base 184 which can define an area for holding water. As shown in FIG. 11, the wall member 186 can have a variable length around the perimeter of the base 184. As one example, the wall member 186 can include a lowered portion 188, where the length of the wall member is shortened (or is removed entirely) relative to the surrounding wall member 186. As will be described in more detail herein, this lowered portion 188 can provide a specific location for water to flow out of a tray member 154 (e.g., at the first end 185 of the tray member 156). The wall member 186 can also include a raised portion 190, which can be lengthened relative to the surrounding wall member 186. In some examples, the raised portion 190 can be positioned opposite the lowered portion 188 (e.g., at the second end 187) and, as will be described in more detail herein, can assist the tray member 156 with receiving water and preventing water from unintentionally flowing over the wall member 186. In some embodiments, the base 184 can include one or apertures 189 for receiving the support members 132 therein.

The tray members 156 can be configured to define a fluid path through a portion of the desalinating device 138. With reference to FIGS. 6, 7, and 11, water delivered to the desalinating device 138 can flow through the first inlets 146 and into the tray member 154 positioned closest to the roof member 140. Water can continue to flow into this first tray member 156 until the tray member 156 reaches its carrying capacity for water (e.g., until water begins to flow out of the tray member 154). As the first tray member 156 reaches its carrying capacity for water, the water can then begin to flow out of the first tray member 156 and into the next tray member 156 positioned below it. This process can continue for every tray member 156 positioned within the desalinating device 138 (e.g., water flowing from a first tray member 156 into a second tray member 156 positioned below it, from the second tray member 156 into the third tray member 156 below it, etc.). Once the tray member 156 closest to the base member 142 (e.g., the last tray member 156 within the desalinating device 138) reaches its carrying capacity for water, water will begin flowing out of that tray member 156 and into the channel 176 of the base member 142. The water can then proceed to flow out of the desalinating device 138 by flowing through the apertures 178 and to the first outlets 150 or to a roof member 140 of a separate desalinating device 138 (e.g., for desalinating devices 138 in a stacked configuration).

The tray members 156 can be configured within the desalinating device 138 so that water from the preceding tray member 156 can reliably flow into the next tray member 156. In some examples, the tray members 156 can be configured so that water will flow out of the lowered portion 188 of one tray member 156 and into the base 184 of the tray members 156 positioned below it. To ensure the water reliably flows into the next tray member 156, the tray members 156 can be laterally offset from the adjacent tray members (e.g., the tray members 156 above and/or below) to produce a staggered arrangement. Additionally, the tray members 156 can be oriented so that the first and second ends 185, 187 of the tray members 156 alternate. For example, as shown in FIG. 7, the second end 187 of one tray member 156 can extend beyond (e.g., be positioned closer to the wall member 184) than the first end 185 of the adjacent tray member 156. In this arrangement, water flowing out of the tray member 156 at the first end 156 (e.g., at the lowered portion 188) can reliably flow into the base 184 of the next tray member 156 (e.g., near the second end 187 of the tray member 156). Additionally, in some of these arrangements, or otherwise, the alternating orientation of the first and second ends 185, 187 of the tray members 156 can create a zigzag like fluid path where the water from one tray member 156 can flow into the next tray member 156 near (or at) the second end 187, flow across that tray member 156 to the first end 185, and flow out of its lowered portion 188 and into the following tray member 156 near (or at) that tray members 156 second end 187. In some examples, the second end 187 of the tray members 156 can include the raised portion 190, which can substantially prevent water from unintentionally flowing over (or splashing over) the second end 187 of the tray member 156.

In some examples, the tray members 156 can be coupled to one or more heating elements. These heating elements can be configured to maintain the temperature of the water flowing through the desalination device 138 so that the water may more readily evaporate. Additionally, in some embodiments, the tray members 156 may include one or more features that can prevent water held within the tray members 156 from splashing. For instance, the tray members 156 can include ribs along the base 184 or wall members 186.

FIG. 12 illustrates a perspective view of the wall member 144 with a portion of the wall member 144 hidden for clarity. As shown in FIG. 12, the wall member 144 can define the inner volume 153 and can extend between a first end 192 and a second end 194. In some examples, the roof member 140 can couple to the wall member 144 at the first end 192 and the base member 142 can couple to the wall member 144 at the second end 194. In some embodiments, the wall member 144 can define a channel 196 at (or near) the second end 194 of the wall member 144. The channel 196 can be used to capture freshwater that is produced from the desalination process. As shown in FIG. 12, the channel 196 can be defined by the inner face 197 of the wall member 144, a base 198, and a wall 200 that extends out from the base 198. The channel 196 can also include an aperture 202 for discharging (or draining) any captured water to the second outlet 152 (or the roof member 140). In some examples, the base 198 can be sloped so that any water within the channel 196 can be directed to aperture 202. In some examples, a plate 204 can be coupled to the wall 200. As shown in FIG. 12, the plate 204 can be sloped so that any water that flows onto the plate 204 can be directed to an opening 206 positioned adjacent the plate 204, which can provide access to the base member 142 of the desalinating device 138 or a roof member 140 of a separate desalinating device 138.

In some embodiments, the wall members 144 can be configured to trap heat within the desalinating devices 138. For example, the wall members 144 can be coupled to insulation, which can help the desalinating devices 138 maintain the temperature of the water within the desalinating devices 138. Additionally, in some embodiments, the wall members 144 can include one or more features for capturing water evaporation. For instance, in some embodiments, the inner face 197 of the wall members 144 can be textured.

With reference to FIGS. 4-12, the operation of the desalinating device 138 will now be described. Water can be delivered to the desalinating device 138 where the water can flow into the inner volume 153 of the desalinating device 138 through the first inlets 146. In some examples, water can be pumped into the channels 166 of the roof member 140, where the water can naturally flow into the first inlets 146. In other examples, water can be directly pumped to the first inlets 146. As the water flows into the inner volume 153, the water can begin to flow into and fill the tray members 156 within the desalinating device 138. During this process, some water within the desalination device 138 can evaporate and can be collected as freshwater. To collect the evaporated freshwater, the evaporation can be directed to the inner face 197 of the wall member 144, where the water evaporation can then condense as freshwater and flow into the channel 196 for collection. The collected freshwater within the channel 196 can then be directed to the aperture 202 where the freshwater can be directed to the second outlet 152. The remaining water (e.g., the non-evaporated water) can continue to flow through the tray members 156 until the water reaches the tray member 156 closest to the base member 142 (e.g., the last tray member 156 in the inner volume 153). Once this tray member 156 reaches its carrying capacity for water, water will begin flowing out of that tray member 156 and into the channel 176 of the base member 142, where the water can flow to the first outlets 150 by flowing through the apertures 178 within the channel 176. This water can be collected as waste (e.g., wastewater) and can be disposed or recycled through the desalinating devices 138.

To ensure the water evaporation is collected, the desalinating devices 138 can be configured to direct water evaporation to certain areas within the desalinating devices. For example, water evaporation can be directed by the tray members 156 to the inner face 197 of the wall member 144 for collection. In some of these examples, or otherwise, the tray members 156 can direct water evaporation to the wall member 144 by being positioned at a slightly angled position relative to a horizontal plane (e.g., between about 0.5 and 15 degrees) within the inner volume 153 (e.g., the tray members 156 are tilted within inner volume 153). With this arrangement, water evaporating from a tray member 156 can be directed by the angled underside of tray member 156 positioned above it to the wall member 144. In some examples, the underside of the roof member 140 can also be sloped or can include one or more angled plates so that the evaporation (or condensation) is directed to the inner face 197 of the wall member 144 via the slope underside or angled plates. In various examples, the tray members 156 can be spaced apart from the inner face 197 of the wall member 144 so that any condensation that accumulates on the inner face 197 can flow down the inner face 197 and into the channel 196 for collection unimpeded by the tray members 156.

To improve the efficiency of the desalination process, the water being delivered to the desalinating devices 138 can be preheated (e.g., via the thermal system 108), which can help the water evaporate more readily. In some examples, the water can be heated to a temperature below boiling (e.g., below 212 degrees Fahrenheit). While the water can more easily evaporate at a higher temperature, using water at or above boiling can require more durable materials that can withstand the high heat. Additionally, the boiling water can leave behind more waste (e.g., minerals) within the desalination system 100, which can be difficult to clean and dispose of. Accordingly, in some examples, the water delivered to the desalinating device 138 can be between about 100 to 200 degrees Fahrenheit, between about 125 to 175 degrees Fahrenheit, and, in some instances, between about 140 to 150 degrees Fahrenheit. Delivering water at these temperatures to the desalinating devices 138 can still allow for evaporation to occur without needing materials that can withstand boiling water and without needing to manage the higher output of waste.

In some embodiments, the desalinating devices 138 can be arranged in a stacked configuration. For example, one desalinating device 138 can be coupled to the roof member 140 of a separate desalinating device 138, thus arranging the two desalinating devices 138 in a stack. In some of these examples, or otherwise, water flowing out of one desalinating device 138 may flow directly into a second desalinating device 138. Additionally, in some instances, one desalinating device 138 may exclude the base member 142 so that freshwater and/or wastewater can flow directly to the roof member 140 of the subsequent desalinating device 138. For instance, the water flowing out of the last tray member 156 in one desalinating device 138 can flow into the channel 166 of the roof member 140 positioned below it and water flowing from the aperture 202 can be directed to the second inlet 148, where the water can flow through the waterline 154.

In some examples, it may be desirable to control the flow rate of water within the desalinating devices 138. For instance, it may be desirable to have the flow of rate of water into the desalinating devices 138 substantially match the flow rate of water out of the thermal system 108. To control the flow rate of water within the desalinating devices 138, the desalinating system 110 can be coupled to one or more pumps which can pumping water into the desalination system 110 at the desired flow rate. In some examples, the optimal flow rate of water can be at least about 0.5 gallons per minute, at least about 1 gallon per minute, at least about 1.5 gallons per minute, at least about 2 gallons per minute, at least about 2.5 gallons per minute, at least about 3 gallons per minute, at least about 3.5 gallons per minute, at least about 5 gallons per minute, at least about 10 gallons per minute, at least about 25 gallons per minute, or more.

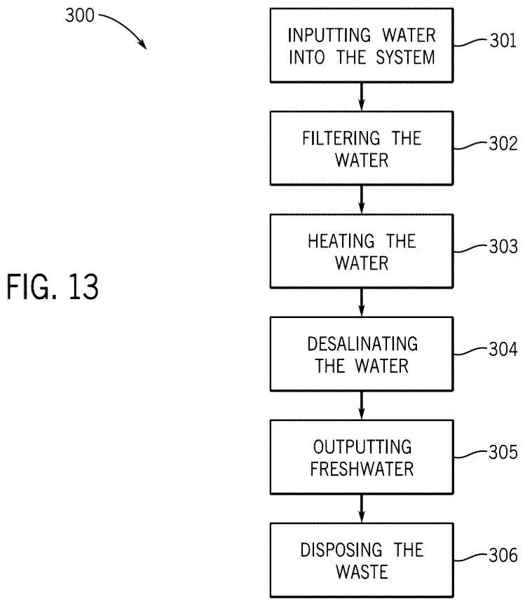

FIG. 13 is a flow diagram illustrating an example method 300 of desalinating water. The method 300 can be used with any of the desalination systems described herein, including the desalination system 100.

At step 301, the method 300 can begin with intaking water into the desalination system. In some examples, an intake system (e.g., the intake system 102) can be used to intake water into the desalination system. For instance, the intake system can include canals, piping, pumps, and/or other components that can direct water from a water source (e.g., the ocean, a bay, a river, lake, reservoir, etc.) and into the desalination system. Accordingly, in some examples, intaking the water into the desalination system can include pumping water from a water source to a system within the desalination system.

At step 302, the method 300 can optionally include filtering the water. In some examples, a filtering system (e.g., the filtering system 104) can be used to filter water. The filtering system can include any suitable components for filtering out debris, such as sand, rocks, animals, plants, and other material from the water. In some examples, the filtering system can filter water that is delivered into the desalination system by the intake system. For instance, water can be pumped from a water source and to the filter system for filtering. However, in other examples, the filtering system can also filter the water at other stages of the desalination process in addition to (or in lieu of) filtering the water as it is being delivered into the system.

In some examples, the method 300 can optionally including storing the filtered water. For instance, after the water has been filtered by the filtering system, the filtered water can be stored in any suitable storage system (e.g., the holding system 106) by pumping the filtered water to the suitable storage system until the filtered water is needed.

At step 303, the method 300 can optionally include heating the water. In some embodiments, the desalination system can include a thermal system (e.g., the thermal system 108) which can be configured to heat water. In some of these embodiments, or otherwise, the thermal system can include one or more thermal devices (e.g., the thermal devices 118) that can heat water. Accordingly, in some examples, heating the water can include pumping water to and through the thermal device so that the thermal device can heat the water to the desired temperature. In some embodiments, the thermal device can heat the water with solar energy. For instance, the thermal devices can be made from a material that heats up under sunlight (e.g., steel pipes) so that when water is pumped through the thermal devices, some of the heat from the sunlight can be transferred to the water. In some examples, the water can be heated to any desirable temperature, including, for instance, between about 140 degrees to about 150 degrees. In some of these examples, or otherwise, the water is pumped through the thermal devices at a specific flow rate (e.g., two gallons per minute, etc.) which can help ensure the water has enough exposure within the thermal devices to reach the desired temperature.

At step 304, the method 300 can include desalinating the water. In some examples, the water can be desalinated with a desalinating system (e.g., the desalinating system 110). For instance, the desalinating system can use one or more desalinating devices (e.g., the desalinating devices 138) to evaporate water and capture the water evaporation as freshwater. In some examples, to capture the water evaporation, the desalinating devices can direct the water evaporation to a wall member (e.g., the wall member 144). For instance, one or more tray members (e.g., the tray members 156) positioned within the desalinating devices can be angled so that the angled tray members can direct the water evaporation to the wall member. As the water evaporation reaches the wall member (e.g., the inner face 197 of the wall member), the water evaporation can condense and trickle down into a channel (e.g., the channel 196) where the fresh water can be collected. In some examples, the desalinating devices can be configured to receive water from the thermal system. For instance, heated water from the thermal system can be pumped into the desalinating system, which can allow for the water to evaporate for desalination more easily.

In some examples, steps 303 and 304 can be repeated as many times as desired, including with water left over from the initial desalinating process. For instance, after desalinating an initial amount of water, the remaining wastewater (e.g., the water that was not captured as freshwater) can be pumped to the thermal system to be reheated and then pumped through the desalinating system to produce more freshwater from this wastewater. In some examples, the wastewater from the initial desalinating process can be recycled through the thermal devices and desalinating system once, twice, three times, four times, or more.

In some embodiments, the method 300 can include pumping freshwater through the thermal system, the desalinating system, or other systems/components of the desalinating system. Pumping freshwater through the thermal system and the desalinating system can clean these systems by removing any salt (or other waste) build up. In some examples, the freshwater pumped through the thermal system and the desalinating system can be freshwater that was initially produced by the desalinating process. After pumping freshwater through these systems, this water can be collected as waste for disposal.

At step 305, the method 300 can optionally include outputting the freshwater. In some examples, the freshwater produced by the desalinating process can be captured and stored in a storage system, such as a holding system. This freshwater stored in the holding system (or, in some examples, the freshwater directly from the desalinating system) can be pumped to a separate desired system for use.

At step 306, the method 300 can optionally including disposing the waste. In some examples, the waste can be disposed of by placing the remaining wastewater, in an evaporation pond. While in the evaporation, the wastewater can continue to evaporate, which, in some examples, can leave behind a brine slurry. This brine slurry can be stored in a suitable storage system or disposed of in another suitable manner.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “top”, “bottom”, “vertical”, “horizontal”, “lateral”, etc. in the present disclosure is meant to provide orientation for the reader with reference to the drawings and is not intended to be the required orientation of the components or to impart orientation limitations into the claims. Where appropriate from the context, language used to denote an approximation, such as “approximately”, “substantially”, “about”, “near”, etc. can refer to standard engineering tolerances. Additionally, or alternatively, where appropriate, language used to denote an approximation can refer to plus or minus 1%, 5%, 10%, or 15% of the described or implied value.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

1. A desalination system for desalinating a liquid, the desalination system comprising:
a thermal device having an inlet for receiving the liquid and an outlet for discharging the liquid, wherein the thermal device is configured to heat the liquid as the liquid flows between the inlet and the outlet; and
a desalinating device fluidly coupled to the thermal device such that the desalinating device is configured to receive the liquid from the outlet of the thermal device, wherein the desalinating device is configured to desalinate the liquid to produce freshwater.

2. The desalination system of claim 1, wherein the desalinating device includes a wall member that extends between a first end and a second end and defines an inner volume for receiving the liquid.

3. The desalination system of claim 2, wherein the wall member includes a channel at or near the second end of the wall member for collecting the freshwater.

4. The desalination system of claim 2, wherein the desalinating device includes a plurality of tray members disposed within the inner volume defined by the wall member, and wherein the plurality of tray members is configured to hold at least a portion of the liquid.

5. The desalination system of claim 4, wherein the wall member defines an inner face, and wherein each tray member of the plurality of tray members is spaced apart from the inner face.

6. A desalinating device for desalinating a liquid, the desalinating device comprising:
a wall member having a first end and a second end and defining an inner volume extending between;
a roof member coupled to the first end of the wall member; and
a plurality of tray members coupled to the roof member, wherein each tray member is configured to hold the liquid.

7. The desalinating device of claim 6, wherein the plurality of tray members are positioned in a staggered arrangement.

8. The desalinating device of claim 6, wherein each tray member of the plurality of tray members defines a first end for discharging the held liquid and a second end for receiving liquid.

9. The desalinating device of claim 8, wherein the first end includes a wall having a lowered portion.

10. The desalinating device of claim 6, wherein each tray member of the plurality of tray members is spaced apart from the wall member.

11. The desalinating device of claim 6, wherein the roof member defines a channel for receiving the liquid.

12. A method of desalinating a liquid, comprising:
pumping the liquid to a thermal device;
heating the liquid with the thermal device to a temperature;
pumping the liquid to a desalinating device; and
desalinating the liquid with the desalinating device to produce freshwater.

13. The method of claim 12, wherein the desalinating device includes a wall member that extends between a first end and a second end and defines an inner volume for receiving the liquid.

14. The method of claim 13, wherein desalinating the liquid includes evaporating the liquid to produce water evaporation.

15. The method of claim 14, further comprising capturing the water evaporation.

16. The method of claim 14, further comprising directing the water evaporation to an inner face of the wall member.

17. The method of claim 12, wherein the thermal device includes an inlet pipe having an inner bore that defines an inlet for receiving the liquid, an outlet pipe having an inner bore that defines an outlet for discharging the liquid, and a pipe member coupled to and extending between the inlet pipe and outlet pipe.

18. The method of claim 17, wherein heating the liquid includes pumping the liquid from the inlet pipe, through the pipe member, and to the outlet pipe.

19. The method of claim 18, wherein the liquid is pumped at a flow rate of at least about 2 gallons per minute.

20. The method of claim 12, wherein the temperature is between about 140 degrees Fahrenheit to about 150 degrees Fahrenheit.
